(19) United States
(12) Patent Application Publication
(10) Pub. No.: US 2004/0198853 A1
(43) Pub. Date: Oct. 7, 2004

(54) Foam article, method for production thereof and reflecting plate

(76) Inventors: Hiromu Saito, Tokyo (JP); Takafumi Oda, Tokyo (JP); Hiroshi Kawato, Ichihara-shi (JP); Toshitaka Kanai, Ichihara-shi (JP); Nobuhiro Watanabe, Ichihara-shi (JP); Takehito Konakazawa, Ichihara-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/486,241

(22) PCT Filed: Aug. 7, 2002
(86) PCT No.: PCT/JP02/08062

(30) Foreign Application Priority Data
Aug. 8, 2001 (JP) 2001-241373

(51) Int. Cl. C08J 9/00; C08K 3/00; B32B 3/26; B29C 39/00; B29C 44/00

(52) U.S. Cl. 521/79; 521/81; 521/90; 264/415

(57) ABSTRACT

Carbon dioxide in a supercritical state is caused to permeate into a resin composition formed by sufficiently kneading a thermoplastic copolymer having a polysiloxane structure at recurring units. Subsequently, the resin composition is degassed by cooling and/or pressure reduction. As a result of degassing, a resin foam body 1 having a fine and uniform micro-cellular foam structure is obtained. The resin foam body 1 has a cyclic structure in which a resin phase 2 and a pore phase 3 are continuous and intertwined. The resin foam body 1 shows an excellent reflectivity relative to rays of light and is highly nonflammable, while it is very strong and lightweight.

### TECHNICAL FIELD

The present invention relates to a foam body produced by causing a resin composition to foam finely, a method of manufacturing such foam body and a reflecting plate. More particularly, the present invention relates to a foam body including micro-cells having a foam cell diameter not greater than 10 μm and a method of manufacturing such foam body. The present invention also relates to as reflecting plate having such foam body.

### BACKGROUND ART

There are a variety of articles that are required to be lightweight and highly reflective while having state-of-the-art or even improved physical properties including strength, rigidity and impact-resistance so as to be used for OA apparatus, electric and electronic apparatus and parts, automobile parts and the like. To meet the demand for such articles, various proposals have been made to raise the reflectance of such items by adding titanium oxide to a relatively large extent or by using a foam body obtained by causing gas in a supercritical state to permeate into PET (polyethylene terephthalate) and degassing the foam body.

However, when the reflectance of such an article is raised by adding titanium oxide to a relatively large extent, its weight and/or cost also rise. A satisfactory level of reflectance cannot be achieved by using a foam body obtained by causing gas in a supercritical state to permeate into PET and degassing the foam body. Additionally, such a foam body entails the problem of a relatively poor nonflammability and hence the scope of its application is limited.

On the other hand, Japanese Patent Laid-Open Publication No. 10-175249 discloses a method of nonflammable micro-cells by compounding thermoplastic resin and organopolysiloxane, causing gas in a supercritical state to permeate into the resin composition and subsequently degassing the compound to allow it to foam. However, the cells formed by the method disclosed in Japanese Patent Laid-Open Publication No. 10-175249 shows a large average cell diameter. The disclosed method also entails a problem that it does not bring forth a high reflectance and a sufficient level of nonflammability.

### DISCLOSURE OF THE INVENTION

In view of the above-identified problems, it is an object of the present invention to provide a foam body and a reflecting plate that are lightweight and show a high reflectance.

A foam body according to an aspect of the present invention is obtained by causing gas in a supercritical state to permeate into thermoplastic resin and subsequently degassing the thermoplastic resin, characterized in that, when the quotient obtained by dividing the sum of the cross sectional areas of all the foam cells observable in the cross section of the foam body by the cross sectional area of the foam body is defined as cell surface area ratio S[%] and the average cell diameter of the foam cells is defined as D[μm], S/D is not smaller than 15.

As a result of intensive research efforts paid for this invention, it was found that, when the quotient of the surface area of a cross section of the foam body divided by the sum of the surface areas of the foam cells observable in the cross section is defined as cell surface area ratio S[%] and the average cell diameter of the foam cells is defined as D[μm], the reflectance is high if S/D is not smaller than 15. Particularly, it is possible to obtain a highly reflective foam body that shows a Y value (reflectance) of not smaller than 95.0 as observed with a visual field angle of 10°, using a D illuminant, if the value of S/D is not smaller than 20. On one hand, the reflectance lowers if the value of S/D is small than 15. It is difficult to apply such a foam body such foam body to OA apparatus, electric and electronic parts and the like required to be highly reflective, in some cases. Therefore, it is preferable to set the value of S/D not small than 15.

While foam cells mostly show a substantially elliptic profile, their profiles can often be distorted. Therefore, an image of a cross section of the foam body, an electron microscope photograph of a cross section of a foam body for example, is taken into an image processing machine and the actual shape of each cell is converted into an ellipse without changing the surface area. Then, the major axis of the ellipse is used as the diameter of the original cell. This image processing operation is conducted on each of all the cells taken into the image and the average value of the obtained cell diameters is defined as average cell diameter D[μm]. As for the cell surface area ratio [%], a cross sectional image of the foam body is typically taken into the image processing machine and processed for binarization to obtain the sum of the void areas of the foam cells, which is then divided by the cross sectional area of the foam body.

In the present invention, preferably, gas in a supercritical state is caused to permeate into a thermoplastic copolymer having a polysiloxane structure at recurring units (to be referred to as polysiloxane copolymer hereinafter) and the polysiloxane copolymer is subsequently degassed.

Such a thermoplastic resin is lightweight and shows an excellent nonflammability and a high reflectance.

Any thermoplastic copolymers having a polysiloxane structure at recurring units (to be referred to as polysiloxane copolymer hereinafter) whose basic structure is expressed by general formula (I) shown below may be used without limitations.

R1ₐ.R2_{b}SiO_{(4-a-b)/2} (I)

In the above general formula (I), R1 represents a monovalent organic group containing an expoxy group. Specific examples of such monovalent organic groups include a γ-glycidoxypropyl group, a β-(3,4-epoxycyclohexyl)ethyl group, a glycidoxymethyl group and an epoxy group. From an industrial point of view, the use of a γ-glycidoxypropyl group is preferable.

In the above general formula (I), R2 represents a hydrocarbon group having 1 to 12 carbon atoms. Examples of such hydrocarbon groups include alkyl groups having 1 to 12 carbon atoms, alkenyl groups having 2 to 12 carbon atoms, aryl groups having 6 to 12 carbon atoms and arylalkyl groups having 7 to 12 carbon atoms. Particularly, phenyl groups, vinyl groups and methyl groups are preferable.

Further, in the formula (I), a and b are numbers that satisfy the relationships of 0<a<2, 0≦b<2 and 0<a+b<2. It is preferable that 0<a≦1. If any organic group (R1) containing epoxy groups is not contained at all (a=0), it is not possible to achieve a desired level of nonflammability because there is no reaction point with a phenolic hydroxyl group at a terminal of aromatic polycarbonate resin. If, on the other hand, a is not smaller than 2, it means that the obtained polysiloxane is expensive and hence disadvantageous in terms of economy. Thus, it is preferable that 0<a≦1.

Meanwhile, if b is not smaller than 2, the heat resistance is poor and nonflammability is reduced because it has a low molecular weight. Thus, it is preferable that 0≦b<2.

Polysiloxanes that meets the above requirements can be manufactured by hydrolyzing an epoxy-group-containing silane such as γ-glycidoxypropyltrimethoxysilane, γ-glycidoxypropylmethyldiethoxysilane, β-(3,4-epoxycyclohexyl)ethyltrimethoxysilane or β-(3,4-epoxycyclohexyl)ethylmethyldiethoxysilane alone or cohydrolyzing such an epoxy-group-containing silane with other alkoxysilane monomer. Any known appropriate cohydrolyzing methods such as the one disclosed in Japanese Patent Laid-Open Publication No. 8-176425 may be used for the purpose of the present invention.

Materials used for a foam body according to the present invention particularly from the viewpoint of strength and impact-resistance necessary for practical applications include copolymers obtained by using a copolymer having a structure expressed by the general formula (I) and some other thermoplastic resin. Examples of such materials include polycarbonate-polysiloxane copolymers, polymethyl methacrylate-polydimethylsiloxane copolymers. Particularly, copolymers that can be obtained by using a polycarbonate and a polydimethylsiloxane block are preferable. A foam body having a high strength and a high reflectance can easily be obtained by using such a copolymer and making the foam body show a so-called micro-cellular structure. Known polycarbonate-polysiloxane copolymers disclosed in Japanese Patent Laid-Open Publication No. 7-258532 can be used for the purpose of the present invention.

Polytetrafluoroethylene (PTFE) may be added to the above-described polysiloxane copolymer to be used as material for a foam body according to the present invention in order to improve the nonflammability and obtain a dense and uniform foam structure. When polytetrafluoroethylene (PTFE) is used for the purpose of the present invention, its average molecular weight is preferably not smaller than 500,000, more preferably between 500,000 and 10,000,000. Of various polytetrafluoroethylenes (PTFEs), the use of one having fibril formability is preferable because such polytetrafluoroethylene (PTFE) can produce an even higher degree of nonflammability. Polytetrafluoroethylenes (PTFEs) having fibril formability include those classified as Type 3 in ASTM Standards. Specific examples of such chemicals include Teflon 6-J (tradename, available from Du Pont—Mitsui Fluorochemicals Co., Ltd.) and Polyflon D-1 and Polyflon F-103 (tradenames, available from Daikin Chemical Industries, Ltd.). Examples of polytetrafluoroethylenes (PTFEs) that do not fall in Type 3 include Algoflon F5 (tradename, available from Montefluos) and Polyflon MPA FA-100 and F201 (tradenames, available from Daikin Chemical Industries, Ltd). Any of such polytetrafluoroethylenes (PTFEs) may be used alone or two or more than two different polytetrafluoroethylenes (PTFEs) may be used in combination.

For a composition according to the present invention, polytetrafluoroethylene (PTFE) is compounded within a range not smaller than 0.01 mass portions and not greater than 2 mass portions relative to 100 mass portions of thermoplastic resin. No effect is practically recognizable when the compounding ratio is smaller than 0.01 mass portions, whereas the effect of preventing dropping during combustion is not recognizably improved and the anti-impact strength and other physical properties are degraded while the obtained nonflammable resin composition hardly foams when the compounding ratio exceeds 2 mass portions. Thus, polytetrafluoroethylene (PTFE) is preferably compounded within a range not smaller than 0.01 mass portions and not greater than 2 mass portions relative to 100 mass portions of thermoplastic resin.

As for the copolymer obtained by using a polycarbonate and a polysiloxane block, if the total mass of the copolymer is 100%, preferably the polysiloxane block takes not smaller than 0.5 mass % and not greater than 10 mass % and an n-hexane-soluble part takes not greater than 1.0 mass % and shows a viscosity average molecular weight not smaller than 10,000 and not greater than 50,000.

When the molecular weight of the copolymer is smaller than 10,000 its heat-resistance and strength are easily reduced and coarse foam cells can be produced. When, on the other hand, the molecular weight of the copolymer exceeds 500,000 it can be difficult to produce foam. Thus, the average molecular weight of the copolymer is preferably not smaller than 10,000 and not greater than 500,000.

When the n-hexane-soluble part takes more than 1.0 mass %, the impact-resistance and nonflammability are reduced and coarse foam cells can be produced. Thus, if the total mass of the copolymer is 100 mass %, preferably the n-hexane-soluble part takes not greater than 1.0 mass %. The n-hexane-soluble part refers to the part of the copolymer in question that is soluble to and extracted by n-hexane when the n-hexane is used as solvent.

The foam structure of the foam body according to the present invention may be a so-called independent foam body containing independent foam cells or a so-called continuous foam body containing no independent foam cells.

In the case of the continuous foam body, a resin phase and a pore phase are continuously formed in an intertwined manner to typically show a cyclic structure.

In the case of the independent foam body, the average cell diameter of the foam cells is preferably not greater than 10 μm, more preferably 5 μm. The advantage of a micro-cellular structure of maintaining the pre-foaming rigidity may not be sufficiently realized when the average cell diameter of the foam cells exceeds 10 μm. Moreover, there is a possibility that the obtained foam body shows a low reflectance. Thus, the major axis of foam cells is preferably not greater than 10 μm. The obtained foam body normally has a volume not smaller than 1.1 times and not greater than 3 times, preferably not smaller than 1.2 times and not greater than 2.5 times, of the volume of the original composition.

In the case of a continuous foam body having a cyclic foam structure, each cycle has a length not smaller than 5 nm and not greater than 100 μm, preferably not smaller than 10 nm and not greater than 50 μm. The foam structure becomes coarse and hurdle-like when the cycle exceeds 100 μm, whereas the pore phase becomes too small and the advantages of the continuous foam body such as a filtering effect may not be realized when the cycle is smaller than 5 nm. Thus, while there are no limitations to the power by which the volume of the continuous foam body is magnified so long as a cyclic structure is maintained, it is normally not smaller than 1.1 times and not greater than 3 times, preferably not smaller than 1.2 times and not greater than 2.5 times.

Any method may be used to manufacture a foam body according to the present invention so long as it causes gas in a supercritical state to permeate into a nonflammable resin composition as described above and subsequently degas the resin composition. Now, a method of manufacturing a foam body according to the present invention will be described below.

A supercritical state is a state between a gaseous state and a liquid state. A supercritical state appears when the temperature and the pressure of gas exceed certain respective points (critical points) that are specific to the type of gas. In a supercritical state, the effect of permeating into resin becomes intensified and uniform if compared with the effect in a liquid state.

In the present invention, any gas that can permeate into resin in a supercritical state may be used. Examples of gas that can be used for the present invention include carbon dioxide, nitrogen, air, oxygen hydrogen and inert gas such as helium, of which carbon dioxide and nitrogen are preferable.

Both a method and an apparatus for manufacturing an independent foam body by causing gas in a supercritical state to permeate into a resin composition have a molding step of molding the resin composition and a foaming step of causing gas in a supercritical state to permeate into the molded body and subsequently causing the molded body to foam by degassing. A batch foaming method by which the molding step and the foaming step are conducted separately and a continuous foaming method by which the molding step and the foaming step are conducted continuously are known. For example, a molding method and a manufacturing apparatus as disclosed in U.S. Pat. No. 5,158,986 or in Japanese Patent Laid-Open Publication No. 10-230528 can be used.

When an injection or extrusion foaming method (continuous foaming method) of causing gas in a supercritical state to permeate into a nonflammable resin composition in an extruder is used for the present invention, gas in a supercritical state is blown into the resin composition that is being kneaded in the extruder. More specifically, when amorphous resin is used, the temperature in the gas atmosphere is made higher than a level close to the glass transition temperature Tg. To be more accurately, the temperature is made higher than a level lower than the glass transition temperature Tg by 20° C. With this arrangement, the amorphous resin and gas become uniformly compatible. The upper limit of the temperature range that can be used for the present invention may be selected freely so long as it does not adversely affect the resin material, although it preferably does not exceed a level higher than the glass transition temperature Tg by 250° C. If the upper limit exceeds this temperature level, the foam cells or the cyclic structure of the foam body can become too large and the resin composition can be degraded by heat to consequently reduce the strength of the foam body. As far as the present invention is concerned, amorphous resin may be crystalline resin that is not oriented and practically amorphous.

When an injection/extrusion method of causing gas to permeate into crystalline resin in an extruder during an injection/extrusion molding process is used, the temperature in the gas atmosphere is made not higher than the melting point (Tm) plus 50° C. (Tm+50° C.). The resin composition may not be molten and kneaded sufficiently if the temperature in the gas atmosphere is lower than the melting point when gas is caused to permeate into the resin composition, whereas the resin can be decomposed if the temperature in the gas atmosphere is higher than (Tm+50)° C. Thus, the temperature in the gas atmosphere is preferably made higher than the melting point (Tm) and not higher than the melting point plus 50° C. (Tm+50° C.).

When a batch foaming method of causing gas to permeate into the crystalline resin filled in an autoclave, the temperature in the gas atmosphere is made not lower than the crystallizing temperature (Tc) less 20° C. (Tc−20° C.) and not higher than the crystallizing temperature (Tc) plus 50° C. (Tc+50° C.). Even gas in a supercritical state can hardly permeate and only provides a poor foaming effect if the temperature in the gas atmosphere is lower than (Tc−20)° C., whereas a coarse foam structure is produced if the temperature in the gas atmosphere exceeds (Tc+50)° C. Thus, the temperature in the gas atmosphere is preferably made not lower than (Tc−20° C.) and not higher than (Tc+50° C.).

The gas pressure under which gas is caused to permeate into resin is required to be not lower than the critical pressure of the gas, preferably not lower than 15 MPa, more preferably not lower than 20 MPa.

The rate at which gas is caused to permeate into resin is determined on the basis of the power of magnification to be used for foaming the resin. For the purpose of the present invention, it is normally not lower than 0.1 mass % and not higher than 20 mass %, preferably not lower than 1 mass % and not higher than 10 mass % relative to the mass of the resin.

There are no particular limitations to the duration of time during which gas is caused to permeate into the resin and the duration may be appropriately selected depending on the method to be used for permeation and the thickness of the resin. The amount of gas caused to permeate and the cyclic structure are correlated in such a way that the cyclic structure will become large when gas is caused to permeate to a large extent, whereas the cyclic structure will become small when gas is caused to permeate to a lesser extent.

When a batch system is used for causing gas to permeate, the duration is normally not shorter than 10 minutes and not longer than 2 days, preferably not shorter than 30 minutes and not longer than 3 hours. When an injection/extrusion method is used, the duration is not shorter than 20 seconds and not longer than 10 minutes because the efficiency of permeation is high.

A foam body according to the present invention is obtained by causing gas in a supercritical state to permeate into a nonflammable resin composition and subsequently degassing by reducing the pressure. In view of the foaming operation, it is sufficient to lower the pressure of the gas caused to permeate into the resin composition to a level below the critical pressure. However, it is normally lowered to the level of atmospheric pressure from the viewpoint of easy handling and the gas is cooled while the pressure thereof is being lowered. Preferably, the nonflammable resin composition into which gas in a supercritical state has been caused to permeate is cooled to (Tc±20)° C. at the time of degassing. When the resin composition is degassed at temperature outside the above temperature range, coarse foam can be generated and the degree of crystallization can be insufficient to reduce the strength and the rigidity of the produced foam body if the resin composition foams uniformly.

When the injection or extrusion foaming method (continuous foaming method) as described above is used, it is particularly preferable to reduce the pressure applied to the resin composition, into which gas in a supercritical state has been caused to permeate, by retracting the metal mold after filling the metal mold with the resin composition that has been permeated with gas in a supercritical state. As a result of such an operation, no defective foaming occurs at and near the gate and a homogeneous foam structure is obtained.

When the batch foaming method of placing a molded nonflammable resin composition into an autoclave filled with gas in a supercritical state and causing gas to permeate into the resin composition is used, the degassing conditions may be substantially same as those described above for the injection or extrusion foaming method (continuous foaming method). The temperature range of (Tc±20)° C. may be observed for a time period sufficient for degassing.

Regardless if a continuous foaming method or a batch foaming method is used, preferably the resin composition is cooled to a temperature level below the crystallization temperature at a rate lower than 0.5° C./sec in order to obtain a foam structure having uniform and independent foam cells. If the cooling rate exceeds 0.5° C./sec, continuous foam sections can be generated in addition to independent foam cells to baffle the effort of producing a uniform foam structure. Thus, the resin composition is cooled at a rate lower than 0.5° C./sec.

To obtain a foam structure having uniform and independent foam cells, the pressure reducing rate of the resin composition is preferably lower than 20 MPa/sec, more preferably lower than 15 MPa/sec, most preferably lower than 0.5 MPa/sec. Continuous foam sections can be generated apart from independent foam cells to make it impossible to obtain a uniform foam structure when the pressure reducing rate is not lower than 20 MPa/sec. Thus, it is preferable for the purpose of the present invention to maintain the pressure reducing rate of the resin composition to a level lower than 20 MPa/sec. As a result of research, it was found that spherical independent bubbles can be easily formed if the resin composition is not cooled or cooled at a very low rate even when the pressure reducing rate is not lower than 20 MPa/sec.

When, on the other hand, manufacturing a foam body in which a resin phase and a pore phase are continuously formed in an intertwined manner to typically show a cyclic foam structure, gas in a supercritical state is caused to permeate into the resin composition containing crystalline resin and laminar silicate and the resin composition permeated with gas is subjected to rapid cooling and rapid pressure reduction substantially simultaneously. As a result of this operation, a pore phase is produced after degassing and the pore phase and the resin phase are continuous and held to an intertwined state.

A method and an apparatus similar to those used for manufacturing an independent foam cell type foam body are also used for causing gas in a supercritical state to permeate into resin. The temperature and the pressure at which gas in a supercritical state is caused to permeate into the resin composition may also be same as those used for manufacturing the independent foam cell type foam body. After the gas permeation, the resin composition is cooled at a cooling rate not lower than 0.5° C./sec, preferably not lower than 5° C./sec, more preferably not lower than 10° C./sec. While the upper limit of the cooling rate varies depending on the method of manufacturing a foam body, it is 50° C./sec for the batch foaming method and 1,000° C./sec for the continuous foaming method. The pore phase takes a form of independent spherical bubbles and hence it is not possible to obtain the functional feature of a continuous pore structure if the cooling rate is lower than 0.5° C./sec, whereas a large cooling facility is required to raise the cost of manufacturing a foam body if the cooling rate exceeds the upper limit value. Thus, the cooling rate is preferably not lower than 0.5° C./sec and not higher than 50° C./sec for the batch foaming method and not lower than 0.5° C./sec and not higher than 1,000° C./sec for the continuous foaming method.

The pressure reducing rate in the degassing step is preferably not lower than 0.5 MPa/sec, more preferably not lower than 15 MPa/sec, most preferably not lower than 20 MPa/sec and not higher than 50 MPa/sec. The obtained continuous porous structure is frozen and maintained when the pressure is reduced to ultimately equal to 50 MPa or less. The pore phase takes a form of independent spherical bubbles and hence it is not possible to obtain the functional feature of a continuous pore structure if the pressure reducing rate is lower than 0.5 MPa/sec, whereas a large cooling facility is required to raise the cost of manufacturing a foam body if the pressure reducing rate exceeds 50 MPa/sec. Thus, the pressure reducing rate is preferably not lower than 0.5 MPa/sec and not higher than 50 MPa/sec.

The pressure reduction and cooling are conducted substantially simultaneously. The expression of substantially simultaneously as used herein means that errors are allowed so long as the objective of the present invention is achieved. As a result of research, it has been found that no problems arise when the resin permeated with gas is rapidly cooled first and then subjected to rapid pressure reduction, although independent spherical bubbles are apt to be formed in the resin when the resin is subjected to rapid pressure reduction without being cooled.

### BRIEF DESCRIPTION OF THE DRAWINGS

FIGS. 1A and 1B illustrate a resin foam body which is a foam body according to an embodiment of the present invention. FIG. 1A is an enlarged schematic perspective view of a principal part of the resin foam body and FIG. 1B is a two-dimensional schematic illustration of the resin foam body.

FIGS. 2A and 2B illustrate an apparatus for realizing a method (batch foaming method) of manufacturing a resin foam body according to an embodiment of the present invention. FIG. 2A is a schematic illustration of the apparatus for conducting the permeation step of gas in a supercritical state and FIG. 2B is a schematic illustration of the apparatus for conducting the cooling/pressure reducing step.

FIG. 3 schematically illustrates an apparatus for realizing a method (continuous foaming method) of manufacturing a resin foam body according to an embodiment of the present invention.

### BEST MODE FOR CARRYING OUT THE INVENTION

Now, an embodiment of the present invention will be described by referring to the accompanying drawings.

For the purpose of the present invention, a nonflammable resin composition that is made to foam can be manufactured by sufficiently kneading the ingredients of the composition, which will be described hereinafter for Examples, by a known method, such as the use of a blender and subsequent melting and kneading of the mixture by a biaxial kneading machine.

The resin composition is made to foam in order to obtain a foam body characterized by containing foam cells whose average cell diameter is not longer than 10 μm and showing a cyclic structure with a cycle of not shorter than 5 nm and not longer than 100 μm. Hereinafter, a forming method or the like of the foam body will be described. Of foam bodies according to the present invention, those of the independent foam type show a structure similar to known foam bodies having independent foam cells, although the average cell diameter of the foam cells according to the present invention is very small and not longer than 10 μm.

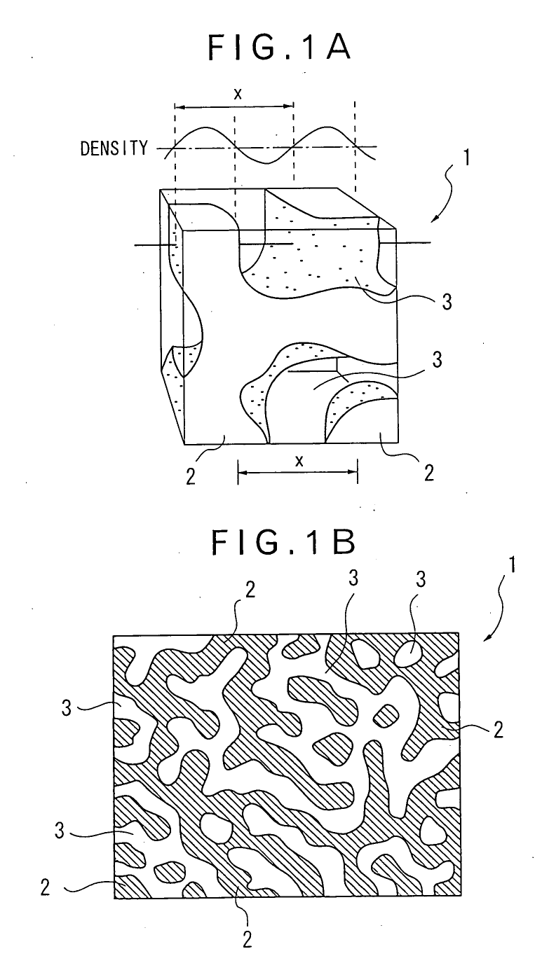

Referring to FIGS. 1A and 1B, reference symbol 1 denotes a resin foam body that is a foam body. A resin phase 2 referred to as matrix phase and a pore phase 3 are continuously formed in the resin foam body 1 and intertwined to show a cyclic structure. The cyclic structure is referred to as modulated structure, in which the density of the resin phase 2 and that of the pore phase 3 fluctuate cyclically. A cycle of fluctuations has a length X equal to that of a cycle of the cyclic structure. In this embodiment, the length X of a cycle is not smaller than 5 nm and not greater than 100 μm, preferably not smaller than 10 nm and not greater than 50 μm.

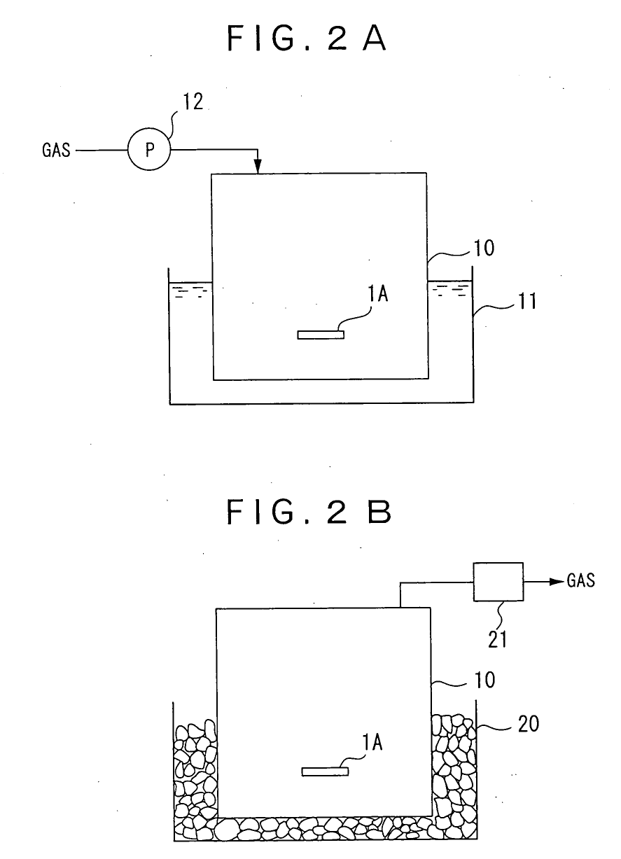

Now, the method of manufacturing the resin foam body 1 according to the embodiment of the present invention will be described by referring to FIGS. 2A and 2B.

FIG. 2A illustrates an apparatus to be used for the permeation step of a batch type foaming method and FIG. 2B illustrates an apparatus to be used for the cooling/pressure reducing step.

Referring to FIG. 2A, the predetermined resin composition 1A is arranged in the inside of an autoclave 10. The autoclave 10 is dipped in an oil bath for heating the resin composition 1A and gas to be caused to permeate into the resin composition 1A is supplied to the inside of the autoclave 10 by a pump 12.

In this embodiment, the temperature of the resin composition 1A is raised to a temperature range not lower than (crystallization temperature [Tc] of the resin composition 1A−20)° C. and not higher than (Tc+50)° C. As a result, the resin composition 1A is put in a gas atmosphere, where the gas is held in a supercritical state.

Referring to FIG. 2B, the autoclave 10 is put into an ice bath 20 with the resin composition 1A held in the inside. The ice bath 20 is such that a coolant such as dry ice and warm water or oil to be used for gradual cooling can be introduced into and discharged from it. The resin composition 1A is cooled as the autoclave 10 is cooled.

A pressure regulator 21 is connected to the autoclave 10 so that the internal pressure of the autoclave 10 is regulated by regulating the amount of gas discharged from the autoclave 10. Note that the ice bath 20 may be replaced by an ice box or a water bath for this embodiment.

When a foam body having independent foam cells is to be obtained by this embodiment, the resin composition 1A that has been permeated with gas is degassed either by cooling or by reducing the pressure of the resin composition 1A. When, on the other hand, a foam body having a cyclic structure as shown in FIGS. 1A and 1B is to be obtained, the resin composition 1A that has been permeated with gas is degassed by rapidly cooling and rapidly reducing the pressure of the resin composition 1A substantially simultaneously. The cooling rate and the pressure reducing rate to be used for the resin composition 1A are found within the above-described respective ranges.

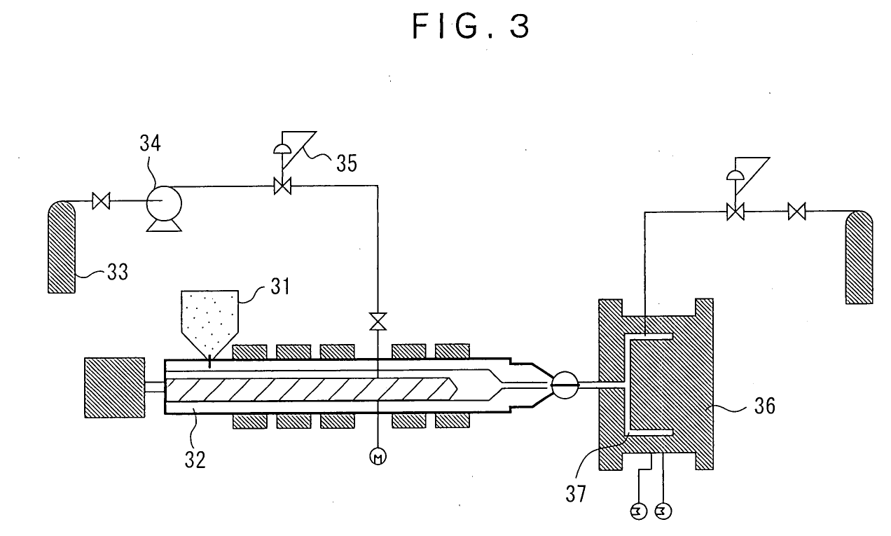

FIG. 3 illustrates an apparatus for realizing a continuous foaming method according to which the permeation step of gas in a supercritical state is conducted during the injection molding operation.

A nonflammable resin composition as described above is put into an injection molding machine by a hopper. Then, the pressure and the temperature of carbon dioxide or nitrogen supplied from a gas cylinder are raised respectively above the critical pressure and the critical temperature thereof by a pressure booster. Then, a control pump is opened and gas blows into the injection molding machine to cause gas in a supercritical state to permeate into the nonflammable resin composition.

The nonflammable resin composition that has been permeated with gas in a supercritical state is then filled in the cavity of a metal mold. If the pressure being applied to the resin composition is reduced as the resin composition flows into the cavity of the metal mold, the gas with which the resin composition has been permeated can escape, if partly, before the cavity of the metal mold is completely filled with the resin composition. Counter pressure may be applied to the inside of the cavity of the metal mold in order to avoid such a situation. When the cavity of the metal mold is completely filled with the resin composition, the mold pressure being applied to the inside of the cavity is reduced. As a result, the pressure being applied to the resin composition is rapidly reduced to accelerate degassing.

If necessary, a foam body according to the present invention may contain an inorganic filler such as alumina, silicon nitride, talc, mica, titanium oxide, clay compound or carbon black, an antioxidant, a photo stabilizer and/or a pigment by not less than 0.01 mass % and not more than 30 mass %, preferably not less than 0.1 mass % and not more than 10 mass %, relative to 100 mass % of the foam body. When strength and rigidity are required to an enhanced level, it may contain carbon fiber or glass fiber by not less than 1 mass % and not more than 100 mass %, relative to 100 mass % of the foam body.

Now, the present invention will be described further by way of specific examples particularly in terms of its advantages. However, the present invention is by no means limited to the examples.

[Regulation of Raw Materials (Compounding Examples 1 through 19)]

The raw materials are dry blended to show compounding ratios shown in Tables 1A and 1B. The ingredients listed in Table 2 are used for the compositions of Tables 1A and 1B.

TABLE 1A

| | nonflammable | | | | | | | | |
|---|---|---|---|---|---|---|---|---|---|
| | MC | | | | | | | | |
| | structure | Resin matrix | | | | | | | |
| | body | | | | PMMA- | | | | |
| | Material | PC | branched PC | PC-PDMS | PDMS | PMMA | PET | PBT | ABS |
| Comp. | cmp ex. 1 | 100 | | | | | | | |
| Example | cmp ex. 2 | 100 | | | | | | | |
| | cmp ex. 3 | | 100 | | | | | | |
| | cmp ex. 4 | | | | | 100 | | | |
| | cmp ex. 5 | | | | | | 100 | | |
| Example | cmp ex. 6 | | | 100 | | | | | |
| | cmp ex. 7 | | | 100 | | | | | |
| | cmp ex. 8 | | | 100 | | | | | |
| | cmp ex. 9 | | | 100 | | | | | |
| | cmp ex. 10 | | | 100 | | | | | |
| | cmp ex. 11 | | | 100 | | | | | |
| | cmp ex. 12 | | | 90 | | | | | |
| | cmp ex. 13 | | | 90 | 10 | | | | |
| | cmp ex. 14 | 50 | | 50 | | | | | |
| | cmp ex. 15 | | 50 | 50 | | | | | |
| | cmp ex. 16 | | 90 | | 10 | | | | |
| | cmp ex. 17 | | | 90 | | | 10 | | |
| | cmp ex. 18 | | | 90 | | | | 10 | |
| | cmp ex. 19 | | | 85 | | | | | 10 |

TABLE 1B

| | nonflammable | | | | | | | | |
|---|---|---|---|---|---|---|---|---|---|
| | MC structure | addtive | | | | | | antioxidant | |
| | body | | organopoly- | | titanium | | | triphenyl- | |
| | material | PTFE | siloxane | silica | oxide | GF | talc | phosphine | phosphate |
| Comp. | cmp example 1 | | | | | | | | |
| Example | cmp example 2 | | 0.5 | | | | | | |
| | cmp example 3 | | | | | | | | |
| | cmp example 4 | | | | | | | 0.1 | |
| | cmp example 5 | | | | | | | 0.1 | |
| Example | cmp example 6 | | | | | | | | |
| | cmp example 7 | | | | | | | | 0.1 |
| | cmp example 8 | | | | | | | 0.1 | |
| | cmp example 9 | 0.3 | | | | | | 0.1 | |
| | cmp example 10 | 0.3 | | 1 | | | | 0.1 | |
| | cmp example 11 | 0.3 | | | 0.5 | | | 0.1 | |
| | cmp example 12 | 0.3 | | | | 10 | | 0.1 | |
| | cmp example 13 | 0.3 | | | | | | 0.1 | |
| | cmp example 14 | 0.3 | | | | | | 0.1 | |
| | cmp example 15 | 0.3 | | | | | | 0.1 | |
| | cmp example 16 | 0.3 | | | | | | 0.1 | |
| | cmp example 17 | 0.3 | | | | | | 0.1 | |
| | cmp example 18 | 0.3 | | | | | | 0.1 | |
| | cmp example 19 | 0.3 | | | | | 5 | 0.1 | |

TABLE 2

| Raw material | Manufacturer | Tradename |
|---|---|---|
| PC | Idemitsu Petrochemical | Tarflon FN1700A |
| | Co., Ltd. | |
| Branched PC | Idemitsu Petrochemical | Tarflon FB2500A |
| | Co., Ltd. | |
| PC-PDMS | Idemitsu Petrochemical | Tarflon FC1700A |
| | Co., Ltd. | |
| PMMA-PDMS | Mitsubishi Rayon Co., Ltd. | SX-005S |
| PMMA | Sumitomo Chemical Co., Ltd. | IT44 |
| PET | Mitsubishi Rayon Co., Ltd. | Sumipex MHF |
| PBT | Mitsubishi Rayon Co., Ltd. | MA-523-V-D |
| ABS | Ube Cycon, Ltd. | AT-05 |
| PTFE | Daikin Chemical Industries, Ltd. | F201L |
| organopolysiloxane | Dow Corning Toray Silicon | SH200 |
| | Co., Ltd. | |
| TBA oligomer | Teijin Ltd. | FG7500 |
| titanium oxide | Ishihara Sangyo Kaisha, Ltd. | CR63 |
| GF (glass fiber) | Asahi Fiber Glass Co., Ltd. | MA409C |
| antioxidant | Johoku Chemical Co., Ltd. | JC-263 |

[Preparation of Film Prior to Foaming (Manufacturing Examples 1 through 18)]

### MANUFACTURING EXAMPLE 1

The specimen of Compounding Example 1 as listed on Table 1 was kneaded in a 35 mmø biaxial kneading/extruding machine at kneading temperature of 280° C. and screw revolving rate of 300 rpm to obtain pellets. The obtained pellets were pressed in a press molding machine at press temperature of 280° C. and gauge pressure of 100 kg/cm² to obtain a 150 mm square×300 μm film.

### MANUFACTURING EXAMPLES 2 THROUGH 18

Films were formed by the 35 mmø biaxial kneading/extruding machine and the press molding machine as in the Manufacturing Example 1 except that the kneading temperature of the kneading operation and the gauge pressure and the press temperature of the press operation were differentiated as shown in Table 3 below for some of the specimens.

TABLE 3

| | preparation of pressed film prior to foaming | | | |
|---|---|---|---|---|
| | | kneading | gauge | press |
| | | tmp. | pressure | temperature |
| step | compounding | [° C.] | [kg/cm²] | [° C.] |
| Manu. Ex. 1 | compound ex. 1 | 280 | 100 | 280 |
| Manu. Ex. 2 | compound ex. 2 | 280 | 100 | 280 |
| Manu. Ex. 3 | compound ex. 3 | 280 | 100 | 280 |
| Manu. Ex. 4 | compound ex. 4 | 240 | 100 | 280 |
| Manu. Ex. 5 | compound ex. 5 | 260 | 100 | 280 |
| Manu. Ex. 6 | compound ex. 6 | 280 | 100 | 280 |
| Manu. Ex. 7 | compound ex. 7 | 280 | 100 | 280 |
| Manu. Ex. 8 | compound ex. 8 | 280 | 100 | 280 |
| Manu. Ex. 9 | compound ex. 9 | 280 | 100 | 280 |
| Manu. Ex. 10 | compound ex. 10 | 240 | 100 | 260 |
| Manu. Ex. 11 | compound ex. 11 | 260 | 100 | 260 |
| Manu. Ex. 12 | compound ex. 12 | 260 | 100 | 260 |
| Manu. Ex. 13 | compound ex. 13 | 260 | 100 | 260 |
| Manu. Ex. 14 | compound ex. 14 | 280 | 100 | 280 |
| Manu. Ex. 15 | compound ex. 15 | 260 | 100 | 260 |
| Manu. Ex. 16 | compound ex. 16 | 260 | 100 | 260 |
| Manu. Ex. 17 | compound ex. 17 | 260 | 100 | 260 |
| Manu. Ex. 18 | compound ex. 18 | 260 | 100 | 260 |

### EXAMPLE 1

The specimen of film, which was a resin composition, obtained in Manufacturing Example 6 in Table 3 was placed in the autoclave 10 (inside dimensions 40 mmø×150 mm) of a supercritical foaming apparatus as shown in FIG. 2A. Then, the internal pressure was raised at room temperature and carbon dioxide in a supercritical state was introduced into the autoclave 10 as gas in a supercritical state. The internal pressure was raised to 15 MPa at room temperature and then the autoclave 10 was dipped into an oil bath 11 at oil temperature of 140° C. for an hour. Subsequently, the pressure valve was opened and the internal pressure was made to fall to the atmospheric pressure in about 7 seconds. Simultaneously, the autoclave 10 was dipped into a water bath at bathing temperature of 25° C. to produce a foam film, which was a foam body.

The obtained foam film was assessed in a manner as described below. The results of the assessment are listed in Table 4.

(1) Average Cell Diameter of Foam Cells, Density and Uniformity of Cells

A cross sectional image of the foam film was processed by an N. I. H. Image ver. 1.57 (tradename) so as to convert the actual shape of each cell into an ellipse without changing the surface area and the major axis was used as cell diameter. Then, the average cell diameter was calculated by using the obtained cell diameters. The uniformity of cells were assessed by observing an SEM photograph.

(2) Nonflammability

The flame of a disposable lighter (S-EIGHT: tradename, available from Hirota Co., Ltd) was adjusted to about 2 cm and a test piece of 5 mm×10 mm obtained by cutting the foam film was exposed to the flame at an end facet thereof for 1 second. The duration from the time when the test piece caught fire and the time when the fire was gone was observed.

(3) Reflectance

The Y value is observed by MS2020 Plus (tradename, available from Macbeth) (D ruminant, visual field angle of 10°).

(4) S/D (Cell Surface Area Ratio/Average Cell Diameter of the Foam Cells)

To determined the cell surface area ratio S[%] a sheet of tracing paper was placed on the SEM photograph and the images of the foam cells that could be observed through the tracing paper were traced. The image obtained by the tracing operation was processed by an image processing machine for binarization to obtain the sum of the void areas of the foam cells. On the other hand, the cross sectional area of the foam film was determined by using the scale of the SEM photograph showing the cross sectional view of the foam film. In other words, the measured longitudinal length was multiplied by the measured transversal length of the image of the SEM photograph to determine the cross sectional area of the foam film. Then, the cell surface area ratio S was calculated by dividing the sum of the cross sectional area of all the foam cells observable in the cross section of the foam film by the cross sectional area of the foam film. The average cell diameter of the foam cells was used as D.

TABLE 4

| | | | | | | | | Reflectance | | |
|---|---|---|---|---|---|---|---|---|---|---|
| | | material to be | foaming condition (permeation of CO₂ for 1 hr) | | | | | (Y-value) | non- | |
| | | assessed | | oil | water | | | D luminant | flammability | |
| | | manufacturing | pressure | bath | bath | ave. cell | cell | visual field | combustion | |
| category | example | example | [MPa] | temp [° C.] | temp [° C.] | dmt [μm] | uniformity | angle of 10° | time (sec) | S/D |
| example | 1 | 6 | 15 | 140 | 25 | 0.7 | ◯ | 101.6 | <1 | 57.1 |
| | 2 | 7 | 15 | 140 | 25 | 0.9 | ◯ | 102.3 | <1 | 60.2 |
| | 3 | 8 | 15 | 140 | 25 | 1 | ◯ | 102.8 | <1 | 60.9 |
| | 4 | 9 | 15 | 140 | 25 | 1 | ◯ | 103.2 | <1 | 63.2 |
| | 5 | 10 | 15 | 140 | 25 | 1 | ◯ | 103.5 | <1 | 66.7 |
| | 6 | 11 | 15 | 140 | 25 | 1 | ◯ | 102.5 | <1 | 60.3 |
| | 7 | 12 | 15 | 85 | 25 | 1 | ◯ | 98.5 | <1 | 25.5 |
| | 8 | 13 | 15 | 140 | 25 | 1 | ◯ | 103.2 | <1 | 63.2 |
| | 9 | 14 | 15 | 140 | 25 | 1 | ◯ | 100.9 | <1 | 24.5 |
| | 10 | 15 | 15 | 140 | 25 | 1 | ◯ | 102.5 | <1 | 64.6 |
| | 11 | 16 | 15 | 140 | 25 | 0.4 | ◯ | 102.1 | <1 | 61.2 |
| | 12 | 17 | 15 | 140 | 25 | 0.4 | ◯ | 101.9 | <1 | 57.1 |
| | 13 | 18 | 15 | 140 | 25 | 2 | ◯ | 97.6 | <1 | 23.6 |
| | 14 | 19 | 15 | 140 | 25 | 1.5 | ◯ | 98.5 | <1 | 27.1 |

### EXAMPLES 2 THROUGH 14, COMPARATIVE EXAMPLES 1 THROUGH 5

The specimens of these examples were obtained by foaming as in Example 1 except carbon dioxide in a supercritical state was caused to permeate into the respective films obtained in Manufacturing Examples as listed in Tables 4 and 5. The results are shown in Table 4 (Examples) and Table 5 (Comparative Examples).

TABLE 5

| | | | | | | | | Reflectance | | |
|---|---|---|---|---|---|---|---|---|---|---|
| | | material to be | foaming condition (permeation of CO₂ for 1 hr) | | | | | (Y-value) | non- | |
| | | assessed | | oil | water | ave. cell | | D luminant | flammability | |
| | | manufacturing | pressure | bath | bath | diameter | cell | visual field | combustion | |
| category | example | example | [MPa] | temp [° C.] | temp [° C.] | [μm] | uniformity | angle of 10° | time (sec) | S/D |
| comp | 15 | 1 | 15 | 140 | 25 | 14 | X | 80.7 | 6 | 2.6 |
| example | 16 | 2 | 15 | 140 | 25 | 9 | X | 81.2 | no died out | 2.8 |
| | 17 | 3 | 15 | 140 | 25 | 3 | X | 86.4 | 6 | 9.7 |
| | 18 | 4 | 15 | 85 | 25 | 20 | X | 98.5 | no died out | 4.2 |
| | 19 | 5 | 15 | 230 | 170 | 15 | X | 98.6 | no died out | 3.6 |

In all Examples, the largest particle diameter of foam cell in every specimen was found to be not greater than 5 μm, while the foam cells were uniform and showed a high reflectance and an excellent nonflammability. Particularly, the specimens of Examples 1 through 3, which were substantially same as those of Comparative Examples 1 and 3 through 5, proved the advantages of the present invention. While the compositions of the antioxidants were slightly different from each other, they did not significantly affect the obtained data. Thus, if Examples 1 through 3 and Comparative Examples 1 and 3 through 5 were compared, the Examples 1 through 3 that were formed by using PC, which was PC-PDMS in some instances, were much more advantageous than Comparative Examples 1 and 3 through 5 in terms of nonflammability, foaming effect and reflectance. This was an unpredictable effect because the films prior to foaming of Examples 1 through 3 and those of Comparative Examples 1 and 3 through 5 showed a substantially same reflectance.

Industrial Applicability

The present invention is applicable to a foam body produced by causing a resin composition to foam finely, a method of manufacturing such a foam body and a reflecting plate. Particularly, the present invention can meet the strong demand for and applications to lightweight and reflecting parts required to have improved physical properties including strength, rigidity and impact-resistance and are used for OA apparatus, electric and electronic apparatus and parts, automobile parts and the like.

1. A foam body obtained by causing gas in a supercritical state to permeate into thermoplastic resin and subsequently degassing the thermoplastic resin, characterized in that, when the quotient obtained by dividing the sum of the cross sectional areas of all the foam cells observable in the cross section of the foam body by the cross sectional area of the foam body is defined as cell surface area ratio S[%] and the average cell diameter of the foam cells is defined as D[μm], S/D is not smaller than 15.

2. The foam body according to claim 1, characterized in that
the thermoplastic resin is a thermoplastic copolymer having a polysiloxane structure at recurring units (to be referred to as polysiloxane copolymer hereinafter).

3. The foam body according to claim 2, characterized in that
the polysiloxane copolymer is at least a polycarbonate-polydimethylsiloxane copolymer or a polymethylmethacrylate-polydimethylsiloxane copolymer.

4. The foam body according to claim 2 or 3, characterized in that
the polysiloxane copolymer is a resin composition containing polycarbonate, polytetrafluoroethylene and a polysiloxane copolymer.

5. The foam body according to any of claims 2 through 4, characterized in that
the polysiloxane copolymer is formed by using a polycarbonate and a polydimethylsiloxane block and, if the total mass of the copolymer is 100 mass %, the polydimethylsiloxane block takes not smaller than 0.5 mass % and not greater than 10 mass % and an n-hexane-soluble part takes not greater than 1.0 mass % and shows a viscosity average molecular weight not smaller than 10,000 and not greater than 50,000.

6. The foam body according to any of claims 1 through 5, characterized in that
the average cell diameter of the foam cells is not greater than 10 μm and the foam body shows a Y value [reflectance] of not smaller than 95.0 as observed with a visual field angle of 10°, using a D illuminant.

7. A method of manufacturing a foam body, characterized in that gas in a supercritical state permeates into a thermoplastic copolymer having a polysiloxane structure at recurring units (to be referred to as polysiloxane copolymer hereinafter) and the polysiloxane copolymer permeated with gas in a supercritical state is subsequently degassed.

8. The method according to claim 7, characterized in that
at least a polycarbonate-polydimethylsiloxane copolymer or a polymethylmethacrylate-polydimethylsiloxane copolymer is used as the polysiloxane copolymer.

9. The method according to claim 7 or 8, characterized in that
a resin composition containing polycarbonate, polytetrafluoroethylene and a polysiloxane copolymer is used as the polysiloxane copolymer.

10. The method according to any of claims 7 through 9, characterized in that
a copolymer formed by using polycarbonate and a polydimethylsiloxane block is used as the polysiloxane copolymer and, if the total mass of the copolymer is 100 mass %, the polydimethylsiloxane block in the copolymer takes not smaller than 0.5 mass % and not greater than 10 mass % and an n-hexane-soluble part takes not greater than 1.0 mass % and shows a viscosity average molecular weight not smaller than 10,000 and not greater than 50,000.

11. The method according to any of claims 7 through 10, characterized in that
when the quotient obtained by dividing the sum of the cross sectional areas of all the foam cells observable in the cross section of the foam body by the cross sectional area of the foam body is defined as cell surface area ratio S[%] and the average cell diameter of the foam cells is defined as D[μm], S/D is not smaller than 15.

12. The method according to any of claims 7 through 11, characterized in that
the average cell diameter of the foam cells is not greater than 10 μm and the foam body shows a Y value [reflectance] of not smaller than 95.0 as observed with a visual field angle of 10°, using a D illuminant.

13. A reflecting plate comprising a foam body according to any of claims 1 through 6.

14. A reflecting plate comprising a foam body manufactured by a method of manufacturing a foam body according to any of claims 7 through 12.
